(19) United States
(12) Patent Application Publication
(10) Pub. No.: US 2014/0050934 A1
(43) Pub. Date: Feb. 20, 2014

(54) CELLULOSIC BARRIER PACKAGING MATERIAL

(71) Applicants: Kai Oliver Siegenthaler, Mannheim (DE); Rainer Blum, Mannheim (DE); Gabriel Skupin, Speyer (DE); Motonori Yamamoto, Mannheim (DE)

(72) Inventors: Kai Oliver Siegenthaler, Mannheim (DE); Rainer Blum, Mannheim (DE); Gabriel Skupin, Speyer (DE); Motonori Yamamoto, Mannheim (DE)

(73) Assignee: BASF SE, Ludwigshafen (DE)

(21) Appl. No.: 14/112,350

(22) PCT Filed: Apr. 16, 2012
(86) PCT No.: PCT/EP12/56892

§ 371 Date: Oct. 17, 2013

Related U.S. Application Data
(60) Provisional application No. 61/477,172, filed on Apr. 20, 2011.

(30) Foreign Application Priority Data
Apr. 20, 2011 (EP) 11 163 105.7

(51) Int. Cl. B65D 65/40; D21C 5/02; C09D 167/04

(52) U.S. Cl. CPC B65D 65/40; C09D 167/04; D21C 5/02
USPC 428/458; 524/539; 162/4; 162/5; 162/8; 428/464

(57) ABSTRACT

A barrier packaging material containing a composite which comprises i) a cellulosic layer; ii) at least one metal layer which will dissolve under alkaline conditions; and iii) at least one polymer layer, in which the polymer is hydrolysable under alkaline conditions. The invention also relates to articles comprising the barrier packaging material. Further, the invention concerns the use of a polymer, which is hydrolysable under alkaline conditions, as a protective layer in barrier packaging products. In addition the present application is also concerned with a method for recycling the aforementioned barrier packaging products. Specifically the barrier packaging products are initially taken in an aqueous wastepaper suspension which is either pulped in an alkaline medium and/or treated in an alkaline medium in a deinking process and in which the metal and polymer are then separated from the cellulosic fibres contained in the cellulosic layer.

The present invention relates to the field of barrier packaging materials and articles made therefrom. The invention also relates to methods of making the barrier packaging materials and recycling of cellulosic material contained in said barrier packaging materials and articles. The invention further relates to the use of polymers for the purpose of making barrier packaging materials.

It is known to provide polymer coated cellulosic cartons in liquid food packaging. Generally such products comprise a layer of cellulosic material, for instance paper or cardboard, interposed between two layers of polymer. Such products are suitable for fresh milk and other fresh liquid foods, but do not exhibit sufficient barrier properties with regard to oxygen and water vapour. Thus, these types of packaging are not suitable for long-term storage milk which requires a good barrier.

For the storage of liquid foods such as sterilised milk and juices it is always necessary to employ packaging products which possess high oxygen and water vapour barrier properties. These packaging products are generally referred to as barrier packaging. It is essential that such packaging products are impervious to moisture and oxygen in order to prevent the food products contained therein from spoiling.

Typically barrier packaging materials are constructed of a cellulosic layer, for instance paper or cardboard, which is coated by at least one composite layer. The composite layer comprises a very thin layer of aluminium between two layers of polyethylene. However, such composite products are generally difficult to recycle and tend to be disposed by incineration or landfill. Consequently the cellulosic material contained within the barrier packaging products would therefore be lost.

German patent application 4328016 relates to delaminatable composites containing layers of plastic, metal foil and/or cellulosic material. The composite contains at least three layers having at least one layer of a polymer which is soluble in a non-neutral, for instance alkaline, aqueous media which is interposed between two layers of the above materials. Such packaging is said to be easily recyclable.

European patent application 855266 describes packaging materials suitable capable of retaining liquids and having heat sealing properties. The packaging material comprises an outer liquid tight, heat sealable coating of plastic, formed from copolymers of styrene with acrylic or methacrylic esters that have been applied onto a fibre material based core. Such packaging material is said to be suitable for recycling.

WO2007109222 reveals oxygen barrier compositions and articles made therefrom based on poly (hydroxyalkanoate), preferably poly lactic acid, a polymer derived from lactic acid, also known as 2-hydroxy propionic acid, and a transition metal. This active barrier composition has been found to consume or scavenge oxygen and can be used in monolithic and multilayer packaging articles which are suitable for containing food products that are sensitive to oxygen, thereby enhancing the quality and shelf life of the product. Such products are said to be biodegradable and suitable for recycling.

Japanese patent application 2000 8265117 describes a multilayer laminated film suitable for storage of food. The multilayered laminate product comprises a light barrier of polybutylene succinate layer containing a black pigment. Such a layer would only be suitable for providing a fat and aroma barrier but the barrier properties with regard to oxygen and water vapour are not sufficient for many high barrier applications.

International application PCT/EP2010/066079, not published at the date of filing of the present application, relates to a method for recycling sized and/or polymer coated paper products, in which the paper products are pulped in the presence of at least one hydrolase in an alkaline medium and/or treated in an alkaline medium in a deinking process. The polymers coating the paper products are biodegradable.

The objective of the present invention is to provide a barrier packaging material with a barrier against oxygen and water vapour high enough for demanding products, such as for the storage of liquid foods such as sterilised milk and juices, and articles formed therefrom which are easily recyclable. It is a further objective to provide a barrier packaging material which provides a barrier at least as effective as conventional barrier packaging materials and/or is more effectively and/or more conveniently recycled in order to recover the cellulosic material contained therein. It is also an objective to provide a suitable recycling process for such barrier packaging products.

Thus according to the present invention we provide a barrier packaging material containing a composite which comprises
i) a cellulosic layer;
ii) at least one metal layer which will dissolve under alkaline conditions; and
iii) at least one polymer layer, in which the polymer is hydrolysable under alkaline conditions.

Desirably the cellulosic layer is paper, cardboard or board. Furthermore, the cellulosic layer suitably may been formed from a conventional process of making paper, cardboard or board. In particular paper, cardboard or board conventionally used for barrier packaging products may be used for the present invention.

Suitable cellulosic fibres for the production of these barrier packaging products include all qualities customary for this purpose, e.g. mechanical pulp, bleached and unbleached chemical pulp, paper stocks from all annual plants and wastepaper (also in the form of broke, both coated and uncoated). These fibers can be used either alone or as any desired mixture with one another for the production of the pulps from which the paper products are produced. Mechanical pulp includes, for example, groundwood, thermomechanical pulp (TMP), chemothermomechanical pulp (CTMP), pressure groundwood, semichemical pulp, high-yield chemical pulp and refiner mechanical pulp (RMP). For example, sulfate, sulfite and soda pulps are suitable as chemical pulp. Suitable annual plants for the production of paper stocks are, for example, rice, wheat, sugar cane and kenaf.

The metal layer may be formed from any metal suitable for use in food packaging which is capable of dissolving under alkaline conditions. Preferably the metal will be aluminium. The metal layer may be in the form of a foil, preferably an aluminium foil or be product of a metallization process. Typically such a metal layer will be any suitable metal layer conventionally used in barrier packaging materials and articles. Suitably this layer may have a thickness of below 250 μm but usually below 20 μm. The metal layer may have a thickness typically below 10 μm. The metal layer may have a thickness as low as 0.01 μm, but often will be greater than this.

The polymer should be capable of imparting a suitable barrier in barrier packaging products, especially barrier packaging products and articles used in the storage of food products over a prolonged period, for instance suitable for sterilised milk and juices.

Non-barrier paper products, i.e. products which do not show an oxygen and water vapour barrier suitable for demanding applications like juice and milk packaging, which are coated with biodegradable polymer (mixtures) are disclosed in WO 2010/034712.

These are as a rule multilayered coatings, usually from 2 to 7 layers and preferably 2 or 3 layers being used in the paper coating.

In addition to being alkali soluble, the polymer employed in the present invention may also be biodegradable. Suitably the biodegradable polymers may be hydrolysable in the presence of a suitable hydrolase enzyme.

Biodegradable polymers are already known to the person skilled in the art and are disclosed, inter alia, in Ullmann's Encyclopedia of Industrial Chemistry (online version 2009), Polymers, Biodegradable, Wiley-VCH Verlag GmbH & Co. KG, Weinheim, 2009, page 131.

In the present invention, the components of the barrier packaging material may for instance be coated with a polyester having a melt volume rate (MVR) according to EN ISO 1133 (190° C., 2.16 kg weight) of from 2 to 50 cm³/10 min and/or polymer mixtures comprising such polyesters.

The components of the barrier packaging material may for instance be coated with a polyester having a melt volume rate (MVR) according to EN ISO 1133 (190° C., 2.16 kg weight) of from 5 to 25 cm³/10 min and particularly preferably from 5 to 12 cm³/10 min.

Of course, barrier packaging materials containing components which are coated with polymer mixtures of different hydrolysable polyesters, such as, in particular, polylactic acid, or with other hydrolysable polymers can also be recycled by the disclosed method. It has proven advantageous that these polymers too have high flowability.

For example, polylactic acid having a melt volume rate (MVR) according to EN ISO 1133 (190° C., 2.16 kg weight) of from 5 to 70 cm³/10 min, particularly preferably from 9 to 50 cm³/10 min and especially preferably from 5 to 25 cm³/10 min has proven useful as a mixing component in such polymer mixtures. Furthermore, mixtures of flowable polyesters with the abovementioned flowable polymer mixtures are suitable for coating the cellulosic and/or metal layers of the barrier packaging material.

Partly aromatic polyesters based on aliphatic diols and aliphatic/aromatic dicarboxylic acids are also understood as meaning polyester derivatives, such as polyetheresters, polyesteramides or polyetheresteramides. The partly aromatic polyesters include linear polyesters whose chains have not been extended (WO 92/09654 A1). In particular, aliphatic/aromatic polyesters of butanediol, terephthalic acid and aliphatic C₆-C₁₈-dicarboxylic acids, such as adipic acid, suberic acid, azelaic acid, sebacic acid and brassylic acid (for example as described in WO 2006/097353 to 56) are suitable mixing components. Chain-extended and/or branched partly aromatic polyesters are preferred. The latter are disclosed in documents WO 96/15173 to 15176, 21689 to 21692, 25446, 25448 or WO 98/12242, which are hereby incorporated by reference. Mixtures of different partly aromatic polyesters are also suitable for the coating of paper products.

Preferred polymers are aliphatic-aromatic polyesters. More preferably such polymers are aliphatic-aromatic polyesters which comprise
i) from 40 to 70 mol %, based on the components i to ii, of one or more dicarboxylic acid derivatives or dicarboxylic acids selected from the group consisting of succinic acid, adipic acid, sebacic acid, azelaic acid and brassylic acid,
ii) from 60 to 30 mol %, based on the components i to ii, of a terephthalic acid derivative,
iii) from 98 to 102 mol %, based on the components i to ii of a C2-C8 alkylenediol or C2-C6-oxyalkylenediol,
iv) from 0.00 to 2% by weight, based on the total weight of the components i to iii, of a chain extender and/or crosslinking agent selected from the group consisting of a di- or polyfunctional isocyanate, isocyanurate, oxazoline, epoxide, carboxylic anhydride and/or an at least trifunctional alcohol or an at least trifunctional carboxylic acid,
v) from 0.00 to 50% by weight, based on the total weight of the components i to iv, of an organic filler selected from the group consisting of native or plasticized starch, natural fibers, sawdust and/or an inorganic filler selected from the group consisting of chalk, precipitated calcium carbonate, graphite, gypsum, conductive carbon black, iron oxide, calcium chloride, dolomite, kaolin, silicon dioxide (quartz), sodium carbonate, titanium dioxide, silicate, wollastonite, mica, montmorillonite, talc, glass fibers and mineral fibers and
vi) from 0.00 to 2% by weight, based on the total weight of the components i to iv, of at least one stabilizer, nucleating agent, lubricant and release agent, surfactant, wax, antistatic agent, antifogging agent, dye, pigment, UV absorber, UV stabilizer or other plastics additive,
   and have a melt volume rate (MVR) according to EN ISO 1133 (190° C., 2.16 kg weight) of from 3 to 50 cm³/10 min.

As described above, the aliphatic-aromatic polyesters are disclosed in WO 2010/034712. This document, as well as the literature cited therein, is hereby incorporated by reference both for the composition of these polyesters and for the method for the preparation thereof.

Among the compounds described there, preferred copolymer mixtures are those which comprise
(a) from 5 to 95% by weight, preferably from 30 to 90% by weight, particularly preferably from 40 to 70% by weight, of a hydrolysable, aliphatic-aromatic polyester and
(b) from 95 to 5% by weight, preferably from 70 to 10% by weight, particularly preferably from 60 to 30% by weight, of one or more polymers selected from the group consisting of polylactic acid, polycaprolactone, polyhydroxyalkanoate, chitosan and gluten and one or more polyesters based on aliphatic diols and aliphatic/aromatic dicarboxylic acids, such as, for example, polybutylene succinate (PBS), polybutylene succinate adipate (PBSA), polybutylene succinate sebacate (PBSSe), polybutylene terephthalate-co-adipate (PBTA), and
(c) from 0 to 2% by weight of a compatibilizer.

Compatibilizers of group (c) are carboxylic anhydrides, such as maleic anhydride, and in particular copolymers containing epoxide groups and based on styrene, acrylates and/or methacrylates. The units carrying epoxide groups are preferably glycidyl (meth)acrylates. Copolymers of the abovementioned type which contain epoxide groups are marketed, for example, by BASF Resins B.V. under the brand Joncryl® ADR. The particularly suitable compatibilizer is, for example, Joncryl® ADR 4368.

Particularly preferred copolymer mixtures therefore comprise
(a) from 20 to 90% by weight, preferably from 30 to 50% by weight, particularly preferably from 35 to 45% by weight, of a hydrolysable, aliphatic-aromatic polyester,
(b) from 80 to 10% by weight, preferably from 70 to 50% by weight, particularly preferably from 65 to 55% by weight, of one or more polymers selected from the group consisting of polylactic acid and polyhydroxyalkanoate and
(c) from 0 to 2% by weight of an epoxide-containing poly(meth)acrylate.

The preferred polylactic acid of group (b) is one which has the following property profile:
a melt volume rate (MVR) at 190° C. and 2.16 kg according to EN ISO 1133 of from 0.5 to 100 ml/10 min, preferably from 5 to 70 ml/10 min, particularly preferably from 9 to 50 ml/10 min,
a melting point below 240° C.,
a glass transition temperature (Tg) of greater than 55° C.,
a water content of less than 1000 ppm,
a residual monomer content (lactide) of less than 0.3% by weight and
a molecular weight greater than 10000 Dalton.

Preferred polylactic acids are, for example, NatureWorks®6201 D, 6202 D, 6251 D, 3051 D and in partricular 3251 D (polylactic acid from NatureWorks).

Polyhydroxyalkanoates of group (b) are primarily understood as meaning poly-4-hydroxybutyrates and poly-3-hydroxybutyrates; copolyesters of the abovementioned hydroxybutyrates with 3-hydroxyvalerates or 3-hydroxyhexanoates are furthermore included. Poly-3-hydroxybutyrate-co-4-hydroxybutyrates are known, in particular from Metabolix. They are marketed under the trade name Mirel®. Poly-3-hydroxybutyrate-co-3-hydroxyhexanoates are known from P&G or Kaneka. Poly-3-hydroxybutyrates are marketed, for example, by PHB Industrial under the brand name Biocycle® and by Tianan under the name Enmat®.

The polyhydroxyalkanoates have as a rule a molecular weight M_{w} of from 100000 to 1000000 Dalton and preferably from 300000 to 600000 Dalton.

Such polymers and polymer mixtures suitable for the polymer layer in the present invention of those identified as suitable in WO 2010/034712.

Preferably the at least one metal layer will be interposed between two layers of the polymer as a multilayer composite. In this case the polymer layers should be in direct contact with the metal layer. The multilayer composite comprising the metal layer and polymer layers should desirably positioned adjacent to a least one side of the cellulosic layer. Preferably the metal/polymer multilayer composite should be in direct contact with one or both sides of the cellulosic layer. In barrier packaging products it would be desirable for the metal/polymer multilayer composite to be on the inner side of the cellulosic layer. When the metal/polymer multilayer composite is only on one side of the cellulosic layer, for instance the side corresponding to the inner side of the barrier packaging product, it may be desirable to have a layer of the polymer on the other side of the cellulosic layer, for instance corresponding to the outer side of the barrier packaging product.

Both extrusion coating and lamination methods are suitable for the production thereof. A combination of these methods is also conceivable.

The polymer may be coated onto the at least one metal layer and if required onto the cellulosic layer. The average grammage in this case is generally 10 to 50 and preferably 15 to 30 g/m².

The grammage is determined by means of punched roundels which have in general a diameter of 4.5 inches (114.3 mm). The roundels are weighed both before and after coating. From the difference in weight and from the known area it is possible to report the grammage in g/m².

However, it may also be desirable to apply multilayer coatings of the polymer onto the metal layer and/or cellulosic layer. As a rule, from 2 to 7 layers and preferably 2 or 3 layers are used in coating of the metal of cellulosic layers. Multilayer coating offers the possibility of individually optimizing the welding properties, the barrier properties, and the adhesion of the coating onto paper, cardboard, board and/or metal layers. The average grammage in this case is generally 10 to 60 and preferably 15 to 35 g/m².

An outer layer or top layer should desirably as a rule be, for example, scratch-resistant and thermally stable and have little tack. The tendency to exhibit tack must be reduced simply to avoid the film sticking to the chill roll in the production process. Preferably, said layer consists of a mixture of from 40 to 60% by weight of an aliphatic-aromatic polyester and from 60 to 40% by weight of polylactic acid and from 0 to 10% by weight of a wax formulation comprising from 0 to 5% by weight of wax, from 0 to10% by weight of dispersant (e.g. metal salts of stearic acid, oleic acid, ethylenebisstearylamide, acid amides (e.g. erucamide, oleamide) and from 0 to 5% by weight of antiblocking agent.

The middle layer desirably should as a rule be stiffer and may also be referred to as a substrate layer or barrier layer. In coating with thin films, the middle layer can also be completely dispensed with. The middle layer preferably comprises from 50 to 100% by weight of polylactic acid and from 0 to 50% by weight of the aliphatic-aromatic polyester.

The inner layer desirably should be the layer in contact with the cellulosic and/or metal layers. It must as a rule be soft and adhere well to the metal, paper, board and/or cardboard layers. It preferably consists of from 50 to 100% of an aliphatic-aromatic polyester and from 0 to 50% of polylactic acid.

The three-layer coating of the metal or cellulosic layers in some cases may be preferred. The coating preferably has the following composition:
i) an outer layer comprising a mixture of from 40 to 60% by weight of an aliphatic-aromatic polyester and from 60 to 40% by weight of polylactic acid and from 0 to 10% by weight of a wax formulation comprising wax, dispersant and antiblocking agents; in general, the outer layer accounts for 20 to 40% of the layer thickness;
ii) a middle layer comprising from 50 to 100% by weight of polylactic acid and from 0 to 50% by weight of the aliphatic-aromatic polyester; in general, the middle layer accounts for 20 to 40% of the layer thickness; and
iii) an inner layer in contact with the metal and/or cellulosic layers, comprising from 50 to 100% by weight of aliphatic-aromatic polyester and from 0 to 50% by weight of polylactic acid. In general, the inner layer accounts for 20 to 40% of the layer thickness.

In some cases the two-layer coating of the metal and/or cellulosic layers is likewise preferred. The coating preferably has the following composition:
i) an outer layer comprising a mixture from 40 to 60% by weight of an aliphatic-aromatic polyester and from 60 to 40% by weight of polylactic acid and from 0 to 10% by weight of a wax formulation comprising wax, dispersant and antiblocking agents; in general, the outer layer accounts for 20 to 50% of the layer thickness;
iii) an inner layer in contact with the metal and/or cellulosic layers and comprising from 50 to 100% of aliphatic-aromatic polyester and from 0 to 50% of polylactic acid. Here, the inner layer generally takes on the support function and/or barrier function. In general the inner layer accounts for 50 to 80% of the layer thickness.

For the multilayer coating of the metal and/or cellulosic layers, in general coextrusion methods are used. Coextrusion coating is preferred.

A suitable lamination method for bonding 2 or more films to give a laminate is extrusion lamination, which is likewise suitable as a coating method.

Extrusion coating may also be employed or coating the metal and/or cellulosic layers. Typically the coating may be applied at speeds of 100 to 600 m/min. The polymers used in the present invention can be processed by existing extrusion coating plants for polyethylene (J. Nentwig: Kunststofffolien, Hanser Verlag, Munich 2006, page 195; H. J. Saechtling: Kunststoff Taschenbuch, Hanser Verlag, Munich 2007, page 256; C. Rauwendaal: L Polymer Extrusion, Hanser Verlag, Munich 2004, page 547).

Barrier packaging articles comprising the aforementioned barrier packaging material also forms part of the present invention.

The present invention further relates to the use of a polymer, which is hydrolysable under alkaline conditions, as a protective layer in barrier packaging products.

Furthermore, the present invention relates to a method for recycling a barrier packaging material containing a composite which comprises
i) a cellulosic layer;
ii) at least one metal layer which will dissolve under alkaline conditions; and
iii) at least one polymer layer, in which the polymer is hydrolysable under alkaline conditions
   in which the barrier packaging products are initially taken in an aqueous wastepaper suspension, this wastepaper suspension
a) is pulped in an alkaline medium, and/or
b) is treated in an alkaline medium in a deinking process,
   and the metal and polymer are then separated from cellulosic fibres contained in the cellulosic layer.

In addition to embodiments a) and/or b) it may also be desirable that the aqueous wastewater suspension is
c) pulped in the presence of at least one hydrolase prior to or during the alkaline treatment.

The aforementioned preferred embodiments pertaining to the barrier packaging material apply also to the barrier packaging material employed in the recycling process.

In the method according to the invention for recycling barrier packaging material containing layers of metal and hydrolysable polymers, an aqueous wastepaper suspension is first prepared from these products. This wastepaper suspension, which generally as a rule has a wastepaper concentration of from 2 to 40% by weight, can
a) be pulped in an alkaline medium and/or
b) be treated in an alkaline medium in a deinking process, and/or
c) be pulped in the presence of at least one hydrolase,

We have found that the hydrolysable polymers may tend to be fragmented and dissolved in the aqueous part of the suspension and as such being separated from the wastepaper. In this way, the cellulosic material is virtually completely, preferably completely, reclaimed.

The embodiments b) and c) according to the invention are distinguished by the method of pulping of the wastepaper suspension. As described at the outset, water is added to the paper product during the pulping, in order first to obtain a wastepaper suspension, and this can be concentrated if necessary or pulped in unchanged concentration. For pulping, the wastepaper suspension is treated in a pulper or a drum disintegrator, the hydrolysable polymers being separated from the paper product by mechanical action. At the same time, the paper product is comminuted. The polymeric residues are then separated from the comminuted paper product via sorting, e.g. via screen baskets.

The recycling process may additionally contain any other wastepaper material or other waste cellulosic material conventionally used in wastepaper recycling processes.

During the process in which the metal layer, for instance aluminium, dissolves hydrogen gas will tend to form and be released. The hydrogen gas may be used as a fuel for power generation, for instance by burning or in a fuel cell.

In the embodiment c), the pulping of the wastepaper suspension is effected in the presence of a hydrolase. Suitable hydrolases [EC 3.x.x.x] are, for example, esterases [EC 3.1.x.x] and proteases [EC 3.4.x.x]. According to the invention, in particular carboxyesterases [3.1.1.1] and/or lipases [3.1.1.3]] and/or Cutinase [3.1.1.74] are used. Examples of these are lipase or cutinase from Achromobacter sp., Aspergillus sp., Candida sp., Candida antarctica, Mucor sp., Penicilium sp., Geotricum sp., Rhizopus sp., Rhizopus arrhizus, Burkholderia sp., Pseudonomas sp., Pseudonomas cepacia, Thermomyces sp., pig's pancreas or wheat germs and carboxyesterases from Bacillus sp., Pseudonomas sp., Burkholderia sp., Mucor sp., Saccharomyces sp., Rhizopus sp., Thermomonospora fusca, Thermobifida fusca, Fusarium solani, Humicola Insolens, Thermoanaerobium sp., pig's liver or horse's liver. Further examples of hydrolases are polyhydroxyalkanoate depolymerase and/or proteinase K and/or savinase. According to the invention, at least one hydrolase may be used, i.e. it is of course possible to use a single hydrolase from among said hydrolases or a mixture of two or more of said hydrolases. However, it is preferable to use only one of said hydrolases in the method according to the invention in the embodiment c) or d).

The hydrolases can be used in free form, preferably in aqueous solution, or in immobilized form.

A lipase or cutinase from Pseudonomas capacia, Burkholderia capacii, Candida antarctica or Rhizopus arrhizus, Thermomonospora fusca, Thermobifida fusca, Fusarium solani, Humicola Insolens in free form, preferably aqueous solution, or in immobilized form (for example Novozym® 435 from Novozymes A/S) is preferred in embodiment a) of the method according to the invention.

The total amount of the hydrolase used is as a rule from 0.001 to 40% by weight, frequently from 0.01 to 15% by weight, preferably from 0.1 to 5% by weight, based in each case on the total solution.

A particular advantage of the embodiment c) is that the hydrolysable polymers are hydrolyzed under alkaline conditions and are thereby separated completely from the paper fiber, in particular the polymeric layers.

Nevertheless in the case of embodiment c) it will be necessary to additionally use either embodiment a) and/or embodiment b) before, during or more usually after embodiment c) in order to remove the metal components of the barrier packaging product. Therefore desirably the process may involve a two-step process comprising of first enzymatic hydrolysis followed by an alkaline treatment step.

In another embodiment a) of the method according to the invention, the pulping of the waste paper suspension is effected in an alkaline medium, i.e. for example in a pH range from 8, for example from 10 to 14, preferably from 12 to 14. For adjusting the pH, a base which is preferably selected from the group consisting of the alkali metal hydroxides and alkaline earth metal hydroxides is added to the wastepaper suspension. Sodium hydroxide solution, potassium hydroxide solution, calcium hydroxide and magnesium hydroxide may be mentioned by way of example. Of course, other hydroxides are also possible. Sodium hydroxide solution is particularly preferably used.

A particular advantage of the embodiment a) is that the hydrolysable polymers and the metal layer dissolve in the alkaline medium and are thereby separated completely from the paper fiber.

The embodiments a) and c) are moreover particularly advantageous for the direct recycling of paper broke. In the production of paper products, this so-called paper broke regularly results, this being a paper product having a lower, undesired quality. This quality-related production broke cannot be reused by the papermaker in the production process. Rather, this broke must be separated off and subjected to a recycling method described in the prior art. The embodiments a) and c) now make it possible for the papermaker to pulp his own paper broke on site in a pulper or a drum disintegrator. The paper fiber obtained in this way can be subjected directly to the process for the production of the paper product.

In the embodiment b) of the method according to the invention, the wastepaper suspension is treated in an alkaline medium in a deinking process.

By deinking, the person skilled in the art understands firstly the flotation deinking process and secondly the wash deinking process. According to the invention, both deinking processes can be carried out in the embodiment b). It is now usual for the wastepaper suspensions which are fed to a deinking process first to be pulped in order already to comminute the paper fiber at least partly.

According to the flotation deinking process, the hydrophobized particles present in the wastepaper suspension after the defibration stage (pulping) and separated from the fibers are attached to air bubbles by collector chemicals and transported by these to the surface of the flotation cell. The dirt-laden foam, which may also comprise fibers and fillers in addition to the impurities and polymer residues, is skimmed off. In order to reduce the fiber loss, the discharged foam is purified before the residue is disposed of after thickening. Usually, inter alia about 2% by weight of sodium hydroxide solution, about 1% by weight of hydrogen peroxide, about 3% by weight of waterglass and further additives in smaller proportions are used as chemical additives. All chemicals are dissolved together in water and added together to the defibrated (pulped) wastepaper suspension. In some recycling plants, the bleaching is carried out separately. It is now usual to subject the wastepaper suspension twice in succession to the flotation deinking process in order thus to achieve the best possible separation of the impurities and polymers from the paper fiber.

The wash deinking process is very widely used, especially in North America. In contrast to flotation, the washing is a dewatering and thickening process. The polymer particles which are detached from the fibers and as small as possible must be thoroughly dispersed so that no further attachment to the fibers can take place during the dewatering of the suspension. For this purpose, the prescribed pH range should be very exactly maintained throughout the process. The dewatering is usually effected in a multistage process, the resulting filtrates, which comprise the detached polymer particles in great dilution, being separated off. A disadvantage of the wash deinking process is that the filler and fiber discharge is substantially higher than in the flotation.

As mentioned above, the method according to the invention in the embodiment b) is possible in both deinking processes. What is essential to the invention is that the wastepaper suspension be initially taken in an alkaline medium and subjected in this form to the deinking process. Alkaline medium means that the wastepaper suspension has a pH from 8, preferably from 10 to 14, particularly preferably from 12 to 14.

The bases described above are suitable for adjusting the pH, sodium hydroxide solution being particularly preferably used.

Here too, it is particularly advantageous that the hydrolysable polymers and the metal components dissolve in the alkaline medium and thus completely separate from the paper fiber.

The method according to the invention is preferably carried out in only one of the embodiments a) or b) described. However, it is also possible to carry out any desired combinations of at least two embodiments, for example embodiment c) and either embodiment a) and/or embodiment b) or alternatively embodiment c) and either embodiments a) and/or b). As a rule, however, one of said embodiments b) or c) is sufficient for achieving complete separation of the hydrolysable polymers and metal from the cellulosic fiber.

The following examples are intended to illustrate the invention without in anyway being limiting.

### EXAMPLE 1

A paper board coated with a blend of 60% PLA and 40% of an aliphatic-aromatic polyester (poly-butylene sebacate-co-terephthalate) was treated at pH 12 in a repulper. After 15 minutes the polymer coating was completely dissolved. The fiber quality as determined by the breaking length of paper made from the repulped fibers was shown not to be negatively influenced by the alkaline treatment.

### EXAMPLE 2

An aluminium foil (thickness: 30 μm) was treated at ambient temperature in an alkaline solution. At a pH of 12 a mass loss through oxidative dissolution was observed. After 60 minutes 35% of the aluminium film was dissolved.

### EXAMPLE 3

An aluminium foil (thickness: 50 pm) was treated at 50 ° C. in an alkaline solution. At a pH of 12 a mass loss through oxidative dissolution was observed. After 60 minutes 75% of the aluminium film was dissolved.

### EXAMPLE 4

An aluminium foil (thickness: 100 pm) was treated at 50 ° C. in an alkaline solution. At a pH of 13 a mass loss through oxidative dissolution was observed. After 30 minutes 25% of the aluminium film was dissolved.

### EXAMPLE 5

A composite material comprising of 5 layers namely a blend of 60% PLA and 40% of polybutylene sebacate-co-terephthalate (10 μm), paper board, a blend of 60% PLA and 40% polybutylene sebacate-co-terephthalate (10 μm), aluminium (7 μm) and a blend of 60% PLA and 40% of poly-butylene sebacate-co-terephthalate (10 μm) was treated in a repulper at pH 12. After 30 min both the polymer coating as well as the aluminium layer were completely dissolved. The fiber quality as determined by the breaking length of paper made from the repulped fibers was shown not to be negatively influenced by the alkaline treatment.

1. A material comprising a composite which comprises:
a cellulosic layer;
a metal layer which will dissolve under alkaline conditions; and
a polymer layer, in which the polymer hydrolyses under alkaline conditions.

2. The material according to claim 1, wherein the metal layer is aluminium.

3. The material according to claim 1, wherein the polymer is an aliphatic-aromatic polyester which comprises:
i) from 40 to 70 mol %, based on the components i to ii, of a dicarboxylic acid derivative or dicarboxylic acid selected from the group consisting of succinic acid, adipic acid, sebacic acid, azelaic acid and brassylic acid;
ii) from 60 to 30 mol %, based on the components i to ii, of a terephthalic acid derivative;
iii) from 98 to 102 mol %, based on the components i to ii of a C2-C8 alkylenediol or C2-C6-oxyalkylenediol;
iv) from 0.00 to 2% by weight, based on a total weight of the components i to iii, of at least one chain extender, crosslinking agent, or both, selected from the group consisting of a di- or polyfunctional isocyanate, isocyanurate, oxazoline, epoxide, carboxylic anhydride, an at least trifunctional alcohol, and an at least trifunctional carboxylic acid;
v) from 0.00 to 50% by weight, based on a total weight of the components i to iv, of at least one organic filler selected from the group consisting of native or plasticized starch, natural fibers, sawdust and an inorganic filler selected from the group consisting of chalk, precipitated calcium carbonate, graphite, gypsum, conductive carbon black, iron oxide, calcium chloride, dolomite, kaolin, silicon dioxide (quartz), sodium carbonate, titanium dioxide, silicate, wollastonite, mica, montmorillonite, talc, glass fibers and mineral fibers; and
vi) from 0.00 to 2% by weight, based on a total weight of the components i to iv, of a stabilizer, nucleating agent, lubricant and release agent, surfactant, wax, antistatic agent, antifogging agent, dye, pigment, UV absorber, UV stabilizer or other plastics additive,
and the polymer has a melt volume rate (MVR) according to EN ISO 1133 at a temperature of 190° C. and at 2.16 kg weight of from 3 to 50 cm³/10 min.

4. The material according to claim 3, wherein the polymer comprises copolymer mixtures which comprise:
a) from 5 to 95% by weight of a hydrolysable, aliphatic-aromatic polyester;
b) from 95 to 5% by weight of at least one polymer selected from the group consisting of polylactic acid, polycaprolactone, polyhydroxyalkanoate, chitosan and gluten and a polyester based on aliphatic diols and aliphatic or aromatic dicarboxylic acids; and
c) from 0 to 2% by weight of a compatibilizer.

5. An article comprising the material according to claim 1.

6. A method comprising forming a protective layer in a barrier packaging product with a polymer, which is hydrolysable in the presence of a hydrolase enzyme under alkaline conditions.

7. A method for recycling a barrier packaging product comprising a composite which comprises:
a cellulosic layer;
a metal layer which will dissolve under alkaline conditions; and
a polymer layer, in which the polymer is hydrolysable under alkaline conditions,
the method comprising:
initially mixing the barrier packaging product in an aqueous wastepaper suspension, in which the wastepaper suspension
is pulped in an alkaline medium,
is treated in an alkaline medium in a deinking process, or both; and then
separating the metal and the polymer from cellulosic fibres in the cellulosic layer.

8. The method according to claim 7, further comprising pulping the wastepaper suspension in the presence of a hydrolase.

9. The method according to claim 7, wherein the wastepaper suspension is pulped in a pulper or a drum disintegrator.

10. The method according to claim 7, wherein a pH of the wastepaper suspension in the alkaline medium is from 8 to 14.

11. The method according to claim 7, wherein a pH of the wastepaper suspension is adjusted by addition of a base selected from compounds of alkali metals and compounds of alkaline earth metals.

12. The method according to claim 8, wherein the hydrolase is at least one selected from the group consisting of a carbooxyesterase, a lipase, and a Cutinase.

13. The method according to claim 8, wherein the hydrolase is at least one selected from the group consisting of a polyhydroxyalkanoate depolymerase, a proteinase K, and a savinase.

14. The material according to claim 3, wherein the polymer comprises copolymer mixtures which comprise:
a) from 30 to 90% by weight, of a hydrolysable, aliphatic-aromatic polyester;
b) from 70 to 10% by weight, of at least one polymer selected from the group consisting of polylactic acid, polycaprolactone, polyhydroxyalkanoate, chitosan and gluten and a polyester based on aliphatic diols and aliphatic or aromatic dicarboxylic acids; and
c) from 0 to 2% by weight of a compatibilizer.

15. The material according to claim 3, wherein the polymer comprises copolymer mixtures which comprise:
a) from 40 to 70% by weight, of a hydrolysable, aliphatic-aromatic polyester;
b) from 60 to 30% by weight, of at least one polymer selected from the group consisting of polylactic acid, polycaprolactone, polyhydroxyalkanoate, chitosan and gluten and a polyester based on aliphatic diols and aliphatic or aromatic dicarboxylic acids; and
c) from 0 to 2% by weight of a compatibilizer.

16. The material according to claim 4, wherein the polyester is polybutylene succinate (PBS), polybutylene succinate adipate (PBSA), polybutylene succinate sebacate (PBSSe), or polybutylene terephthalate-co-adipate (PBTA).

17. The material according to claim 1, wherein the material is a barrier packaging material.
